(19) United States
(12) Patent Application Publication
(10) Pub. No.: US 2003/0211248 A1
(43) Pub. Date: Nov. 13, 2003

(54) High performance absorbent structure including superabsorbent added to a substrate via in situ polymerization

(76) Inventors: Young C. Ko, Neenah, WI (US); Stanley R. Kellenberger, Appleton, WI (US)

Correspondence Address: Pauley Petersen Kinne & Erickson, Suite 365, 2800 West Higgins Road, Hoffman Estates, IL, 60195, US

(21) Appl. No.: 10/443,366

(22) Filed: May 22, 2003

Related U.S. Application Data
(63) Continuation-in-part of application No. 10/017,681, filed on Dec. 14, 2001.

(30) Foreign Application Priority Data
Sep. 12, 2002 (WO) PCT/US02/29050
Dec. 5, 2002 (AR) 020104727

(51) Int. Cl. B05D 3/02

(52) U.S. Cl. 427/385.5

(57) ABSTRACT

An absorbent structure devoid of capillary obstruction (gel blocking) is formed by applying one or more superabsorbent polymer precursor compositions to a substrate at a plurality of predetermined, controlled spaced apart locations using a precision non-contact process, and chemically reacting the precursor composition(s) in situ to form superabsorbent polymer domains adhered to the substrate. The superabsorbent polymer domains have controlled size and spacing so that, when the superabsorbent polymer domains are in a fully swollen state following maximum liquid absorption, adjacent superabsorbent polymer domains will not touch each other and will not block capillaries existing between the domains in the absorbent structure. The absorbent structure has excellent liquid intake and distribution, and optimal absorbent capacity.

This patent application is a continuation-in-part of U.S. patent application Ser. No. 10/017,681, filed on Dec. 14, 2001, the disclosure of which is incorporated by reference.

### FIELD OF THE INVENTION

This invention relates to a stable absorbent structure useful in personal care absorbent articles, medical absorbent articles and the like, in which a superabsorbent polymer component of the absorbent material is formed by adding one or more polymer precursor streams containing monomer, catalyst or the like to a pre-formed substrate, and forming the superabsorbent polymer in situ after the precursor stream(s) contact the substrate.

### BACKGROUND OF THE INVENTION

Processes for making absorbent composite materials having a superabsorbent polymer component are known. In various processes, preformed superabsorbent polymer particles or fibers are combined with cellulose fibers, thermoplastic fibers and the like in a web formation process to make a composite web structure. Illustrative processes are disclosed in U.S. Pat. No. 4,818,464 to Lau, U.S. Pat. No. 4,100,324 to Anderson et al., U.S. Pat. No. 5,350,624 to Georger et al., and U.S. Pat. No. 4,902,559 to Eschwey et al. These processes are commonly referred to as “coform” processes.

Additionally, a process is known where a superabsorbent polymer is only partially formed from a precursor monomer before being added to a fibrous substrate, and the polymerization is completed after the partially polymerized monomer contacts the substrate. U.S. Pat. No. 5,962,068 to Tsuchiya et al. discloses a water-absorptive composite including a fibrous substrate and water-absorptive polymer particles. The water-absorptive polymer is partially polymerized with the aid of a redox initiator before being added to the fibrous substrate. The partially polymerized material is added in a dropwise fashion to the substrate, and the polymerization reaction then proceeds to completion.

One feature that the known processes have in common, is that they require at least some separate process steps for polymerizing or partially polymerizing the superabsorbent material before it can be added to the fibrous substrate. In other words, neither process totally forms the superabsorbent polymer within the fibrous substrate.

### Definitions

The term “cellulose fibers” refers to fibers from natural sources such as woody and non-woody plants, regenerated cellulose, and the derivatives from these fibers by means of chemical, mechanical, or thermal treatment, or any combination of these. Woody plants include, for example, deciduous and coniferous trees. Non-woody plants include, for instance, cotton, flax, esparto grass, milkweed, straw, jute hemp, and bagasse. Regenerated cellulose fibers include, for instance, viscose and rayon. The cellulose derivatives include, for instance, microcrystalline cellulose, chemically crosslinked fibers, and chemically uncrosslinked, twisted fibers.

The term “average pulp fiber length” refers to a weighted average length of pulp determined using a Kajaani fiber analyzer Model No. FS-100 available from Kajaani Oy Electronics in Kajaani, Finland. Under the test procedure, a fiber sample is treated with a macerating liquid to ensure that no fiber bundles or shives are present. Each fiber sample is dispersed in hot water and diluted to about a 0.001% concentration. Individual test samples are drawn in approximately 50 to 500 ml portions from the dilute solution and tested using the standard Kajaani fiber analysis procedure. The weighted average fiber lengths may be expressed by the following equation:

k

Σ(Xᵢ*nᵢ/n)

Xᵢ>0

where

k=maximum fiber length,

Xᵢ=individual fiber length,

nᵢ=number of fibers having length Xᵢ

and n=total number of fibers measured.

The term “meltblown fibers” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than 10 microns in diameter, and are generally self bonding when deposited onto a collecting surface.

The term “spunbonded fibers” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,502,538 to Petersen, and U.S. Pat. No. 3,542,615 to Dobo et al. Spunbond fibers are quenched and generally not tacky on the surface when they enter the draw unit, or when they are deposited onto a collecting surface. Spunbond fibers are generally continuous and may have average diameters larger than 7 microns, often between about 10 and 30 microns.

The term “staple filaments or fibers” means filaments or fibers which are natural or which are cut from a manufactured filament prior to forming into a web, and which have a length ranging from about 0.1-15 cm, more commonly about 0.2-7 cm.

The term “substantially continuous filaments or fibers” refers to filaments or fibers prepared by extrusion from a spinnerette, including without limitation spunbonded and meltblown fibers, which are not cut from their original length prior to being formed into a fibrous web. Substantially continuous filaments or fibers may have lengths ranging from greater than about 15 cm to more than one meter; and up to the length of the fibrous web being formed. The definition of “substantially continuous filaments or fibers” includes those which are not cut prior to being formed into a fibrous web, but which are later cut when the fibrous web is cut.

The term “substrate” includes nonwoven substrates which can be wet-formed, including cellulose webs (e.g. tissues, paper towels, other paper items, boards, other wood items, and the like) or dry-formed (e.g. bonded carded webs, spunbond webs, meltblown webs, cross laid scrims, air laid webs, and the like), woven substrates (e.g. cloth or scrim, and the like), film substrates, foam substrates, and the like. The substrate may be nonextensible, extensible, inelastic, elastic, hydrophobic, hydrophilic and the like.

The term “nonwoven web” means a web having a structure of fibers or filaments which are interlaid, but not in an identifiable manner as in a knitted fabric. “Fibrous” webs include nonwoven webs as well as fibrous webs where the fibers are interlaid in an identifiable (e.g. regular) manner. The terms “fiber” and “filament” are used herein interchangeably. Nonwoven webs have been formed from many processes such as, for example, meltblowing processes, spunbonding processes, air laying processes, and bonded carded web processes. The term also includes films that have been perforated or otherwise treated to allow air to pass through. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

The term “polymer” generally includes but is not limited to, homopolymers, copolymers, including block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

The term “wettable” and/or “hydrophilic” is meant to refer to a fiber which exhibits a liquid such as water, synthetic urine, or a 0.9 weight percent aqueous saline solution, in air contact angle of less than 90°. The contact angle may be determined, for example, in accordance with ASTM D724-89.

The term “thermoplastic” is meant to describe a material that softens and flows when exposed to heat and which substantially returns to its original hardened condition when cooled to room temperature.

The term “superabsorbent polymer precursor composition” refers to any and all solutions which, when mixed, chemically react to form a superabsorbent polymer. Each solution may be comprised of any combination of oligomer(s), monomer(s), crosslinking reagent(s), neutralizing agent, or initiator(s). In instances when only a single solution is utilized all the desired components must be in said solution and the initiator(s) must require a later activation step (e.g. heating or irradiation). In instances when two or more solutions are utilized the initiator(s) is most often, but not limited to, a chemical redox pair. When a redox pair, comprised of an oxidizing radical generator and a reducing agent, is used as the initiator the oxidizing radical generator and reducing agent must be in separate solutions. The solution of oxidizing radical generator or reducing agent may also contain any combination of oligomer(s), monomer(s), crosslinking reagent(s), or neutralizing agent.

The term “superabsorbent material” refers to a water swellable, water-insoluble organic or inorganic material capable, under the most favorable conditions, of absorbing at least about 15 times its weight, preferably at least about 20 times its weight in an aqueous solution containing 0.9% by weight sodium chloride. The term “absorbent material” refers to any material capable of absorbing from about 5 to less than about 15 times its weight of the same solution.

The term “personal care absorbent article” includes diapers, training pants, swim wear, absorbent underpants, adult incontinence products, feminine hygiene products, and the like.

The term “medical absorbent article” includes medical absorbent garments, drapes, gowns, bandages, wipes, and the like.

The term “athletic absorbent article” includes absorbent athletic socks, pants, supporters, bras, shorts, shirts, sweat bands, helmet liners, and the like.

The term “work wear absorbent article” includes laboratory coats, coveralls, hard hat liners, and the like.

The term “tissue and towel article” includes facial and bathroom tissues, paper towels, wet wipes, and the like.

### SUMMARY OF THE INVENTION

The present invention is directed to a process for making an absorbent structure in which a substrate, such as a fibrous web, foam scrim or other suitable material, is initially at least partially formed. Then, a superabsorbent polymer is completely formed in situ on or in the substrate by adding one or more superabsorbent polymer precursor compositions to the fibrous web, and performing the polymerization reaction(s) completely on and/or in the fibrous web.

The superabsorbent polymer precursor composition(s) are applied to the substrate, and caused to react at predetermined controlled locations having controlled size and spacing between them. The chemical reaction causes superabsorbent polymer to form from the precursor composition(s) at the predetermined controlled locations, and to adhere to the substrate. Capillary channels are provided in the substrate between the controlled locations of superabsorbent polymer. The size and spacing of the locations are controlled so that, when the superabsorbent polymer is fully swollen, no two domains of superabsorbent polymer will block the capillary channel(s) between them. In other words, no two domains of superabsorbent polymer will touch each other.

The substrate can be a foam scrim having capillaries formed therein, or a fibrous web including absorbent and/or other hydrophilic fibers and, optionally, thermoplastic fibers and other ingredients, or another suitable material. At least one and, desirably two superabsorbent polymer precursor compositions are provided. If only one superabsorbent polymer precursor composition is provided, then it must contain all of the ingredients (monomer, catalyst and the like) necessary to perform the chemical reaction. If two superabsorbent polymer precursor compositions are provided, one of them may include monomer and the other may include a polymerization initiator. Alternatively, each precursor composition may contain a corresponding component of a chemical redox pair (an oxidizing radical generator and a reducing agent) and, in addition, one or both precursor compositions may also include any combination of oligomer(s), monomer(s), crosslinking reagent(s), and/or neutralizing agent(s). In at least the latter the polymerization reaction proceeds spontaneously, beginning when the two precursor compositions are combined.

The superabsorbent polymer precursor composition(s) are added to the substrate at the predetermined controlled locations using a precision non-contact process. Suitable non-contact processes include precision non-contact printing processes, for instance an ink jet printing process. A “precision” non-contact process is one which can apply the superabsorbent polymer precursor composition(s) to discrete microdomain locations of highly controlled size and spacing, without experiencing any mechanical contact between the printing apparatus and the substrate. If two superabsorbent polymer precursor compositions are employed, they may be added separately, so that they first contact each other on or in the substrate. At least one, and suitably both of the precursor compositions are applied using a precision non-contact process. The precursor composition(s) and process conditions are selected so that the polymerization reaction for making superabsorbent polymer proceeds entirely on or in the substrate.

As a result, the superabsorbent polymer(s) are formed directly onto the surfaces of the substrate or substrate components, such as fibers. The resulting absorbent structure has a controlled, stable composition in which the superabsorbent polymer sticks to the substrate and does not migrate within or away from the substrate. Because of the controlled size and spacing of the superabsorbent polymer domains, capillary action is maintained between the domains even when the superabsorbent is fully swollen due to absorption, and gel blocking is avoided.

Additional surface crosslinking may also be performed on the superabsorbent polymer domains once the initial polymerization has taken place. The surface crosslinking may enhance the absorbent properties of the absorbent structure.

### BRIEF DESCRIPTION OF THE DRAWINGS

FIGS. 1-3 are perspective views of an absorbent structure of the invention showing superabsorbent polymer domains in unswollen, intermediate swollen and maximum swollen states on or in a substrate.

FIGS. 4 and 5 are an exploded view of multi-sectional absorbent structures of the invention.

### DETAILED DESCRIPTION OF THE PRESENTLY PREFERRED EMBODIMENTS

In accordance with the invention, a pre-formed substrate is provided. The substrate may be a fibrous web, a foam scrim, or another suitable material. The substrate may be a nonwoven web, for instance, which contains about 25-100% by weight of absorbent and/or other hydrophilic fibers and about 0-75% by weight of thermoplastic fibers, suitably about 50-100% by weight absorbent and/or other hydrophilic fibers and about 0-50% by weight thermoplastic fibers, desirably about 60-90% by weight absorbent and/or other hydrophilic fibers and about 10-40% by weight thermoplastic fibers. The substrate (e.g. fibrous web) may be formed using any conventional technique.

Suitably, the hydrophilic fibers include cellulose fibers. Examples of cellulose fibers include without limitation wood pulp fibers, wood pulp fluff, curled pulp fibers, microcrystalline cellulose, microfibrillar cellulose, cotton, and the like. Other hydrophilic fibers may also be employed, as well as absorbent staple fibers. Pre-formed superabsorbent particles or fibers may also be included. For purposes of the invention, the superabsorbent polymer is formed in situ as described below.

When thermoplastic fibers are employed, they may include meltblown fibers. The meltblown fibers may be formed from thermoplastic polymers including, without limitation, polyolefins, polyamides, polyester, polyurethane, polyvinyl alcohol, polycaprolactone, styrene butadiene block copolymers or the like. Suitable polyolefins include without limitation polyethylene, polypropylene, polybutylene, copolymers of ethylene with other alpha-olefins, copolymers of propylene with other alpha-olefins, copolymers of butylene with other alpha-olefins, and combinations thereof. Processes for forming absorbent nonwoven webs containing hydrophilic fibers, meltblown fibers, and other optional ingredients are disclosed in U.S. Pat. No. 5,350,624 to Georger et al., U.S. Pat. No. 4,818,464 to Lau; and U.S. Pat. No. 4,100,324 to Anderson et al.; the disclosures of which are incorporated by reference.

When thermoplastic polymers are employed, they may include spunbond fibers formed from any of the thermoplastic polymers listed above as being useful for meltblown fibers. A process for forming absorbent nonwoven webs containing hydrophilic fibers, spunbond fibers, and other optional ingredients is disclosed in U.S. Pat. No. 4,902,559 to Eschwey et al., the disclosure of which is incorporated by reference.

In accordance with the invention, one or more superabsorbent polymer precursor compositions are applied to the substrate, and chemically reacted (polymerized) after addition to the substrate to make the absorbent web structure. The superabsorbent polymer precursor composition(s) are added using a precision non-contact process, such as ink jet printing, in which there is no contact between the substrate and equipment which applies the precursor composition(s). The non-contact (e.g. ink jet printing) process can apply the superabsorbent polymer composition(s) in a variety of regular printing patterns, including diamonds, squares, circles, triangles, polygons, and other specific regular or irregular geometries. The finished shape may range from the above shapes with only minor thickness to fully-defined three-dimensional shapes such as polyhedrons, spheres, ellipsoids and the like. A suitable inkjet printing process is described in U.S. Pat. No. 6,024,438, issued to Koike et al., U.S. Pat. No. 6,019,457, issued to Silverbrook, and U.S. Pat. No. 5,875,969, to Ruth III, the disclosures of which are incorporated by reference.

The superabsorbent polymer precursor composition(s) are applied so as to form domains of superabsorbent polymer at predetermined controlled locations on or in the substrate. The domains of superabsorbent polymer have a regular size and regular spacing such that no two domains of superabsorbent polymer will block the capillaries between the domains even when the superabsorbent polymer domains are fully swollen due to maximum liquid absorption. In other words, the adjacent superabsorbent polymer domains will not touch each other when swollen.

The foregoing principles are illustrated in the drawings. FIG. 1 illustrates an absorbent structure 10 including a fibrous web substrate 12 and superabsorbent polymer domains 14. The superabsorbent polymer domains 14 are in the dry, unswollen state. Capillaries 16, through which a aqueous liquid may pass, exist between each adjacent pair of superabsorbent polymer domains 14.

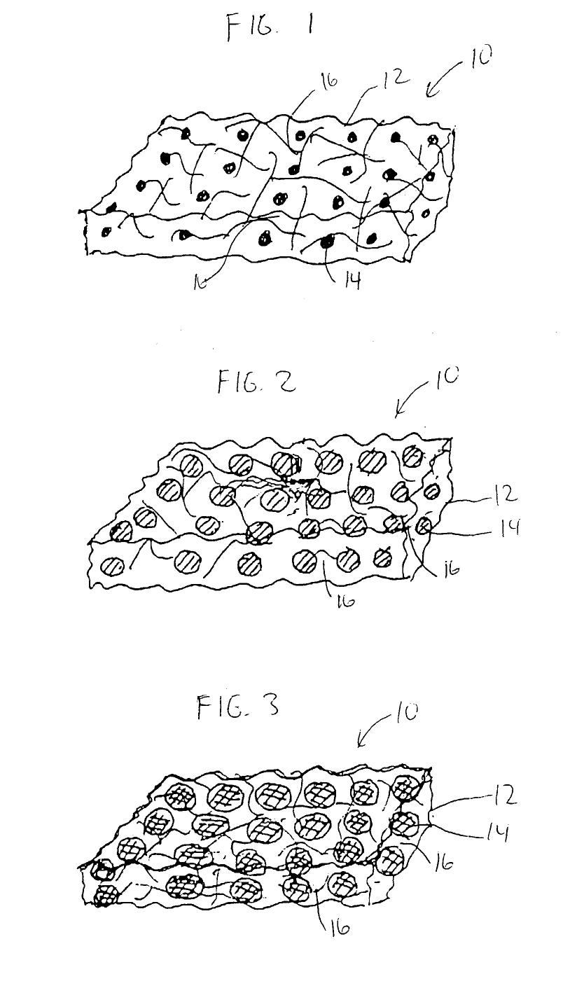

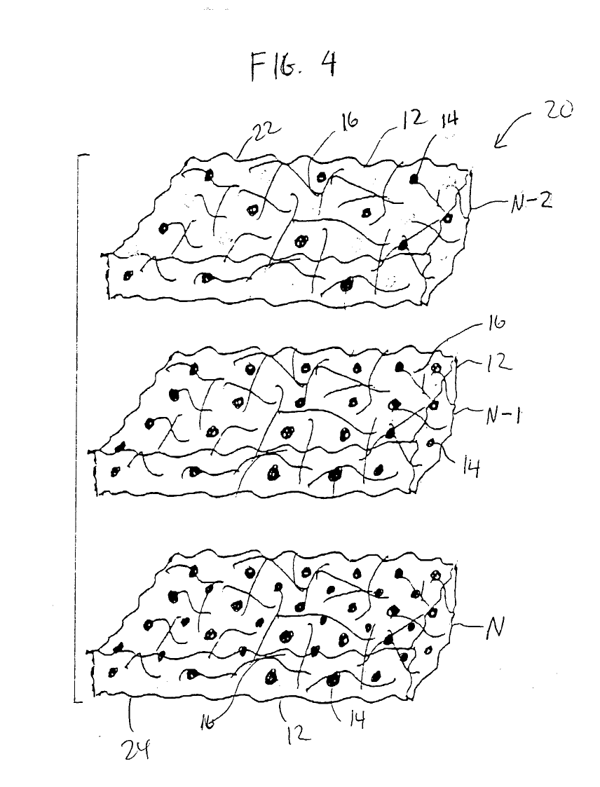

FIG. 2 illustrates the same absorbent structure 10, except that the superabsorbent polymer domains 14 exhibit an intermediate stage of swelling due to some absorption of aqueous liquid. FIG. 3 illustrates the same absorbent structure 10, except that the superabsorbent polymer domains 14 exhibit maximum swelling due to maximum absorption of aqueous liquid. As the superabsorbent polymer domains 14 swell due to liquid absorption, the capillaries 16 between them become smaller. However, even at maximum swelling as illustrated in FIG. 3, the adjacent superabsorbent polymer domains 14 do not touch each other, and the capillaries 16 are not closed or blocked. Capillary action is thus preserved even at maximum liquid absorption, and gel blocking is prevented.

In order to achieve the foregoing objectives, the superabsorbent polymer domains should have a regular domain diameter when in the swollen state. The term “domain diameter” refers to the longest length of a straight line that can be drawn through a superabsorbent polymer domain, from one side to an opposite side. The term “regular domain diameter” means that the standard deviation of the domain diameters of in situ formed superabsorbent polymer domains 14 within the absorbent structure 10 is about 10% or less, suitably about 5% or less, suitably about 3% or less of the mean superabsorbent polymer domain diameter when the superabsorbent polymer domains 14 are in the fully swollen state. Assuming the superabsorbent polymer domains 14 have uniform composition and geometry, the standard deviations (expressed as percent variations from a mean particle diameter) should be the same in the dry, unswollen state, even though the mean diameter would be lower. The standard deviation is determined according to well-known statistical techniques and represents variations from a mean particle diameter in a normal distribution curve.

Based on a normal distribution curve, the most probable diameter of a superabsorbent polymer domain in the fully swollen state (reflecting maximum liquid absorption) is the mean (average) domain diameter for all of the superabsorbent domains 14 in absorbent structure 10. Statistically, about 67% of the superabsorbent polymer domains will have fully swollen diameters within one standard deviation of the mean, about 95% within two standard deviations of the mean, and about 99% within three standard deviations of the mean. For example, an absorbent structure 10 may have a mean superabsorbent domain diameter of 1000 microns in the fully swollen state and a standard deviation of 5%. In this example, about 67% of the superabsorbent polymer domains would have a fully swollen diameter between 950-1050 microns, about 95% would have a fully swollen diameter between 900-1100 microns, and about 99% would have a fully swollen diameter between 850-1150 microns.

The superabsorbent polymer domains 14 will typically have a mean dry (unswollen) diameter which can be approximately determined from the following equation:

$${D}_{unswollen} = \frac{{D}_{swollen}}{\sqrt[3]{( {A}_{s} \times \frac{{ρ}_{S}}{{ρ}_{L}} ) + 1}}$$

where

D_{unswollen}=unswollen diameter of domain

D_{swollen}=fully swollen diameter of domain

A_{S}=maximum absorbency of superabsorbent polymer, in grams aqueous liquid per gram superabsorbent polymer

ρ_{S}=density of superabsorbent polymer in the dry, unswollen state, and

ρ_{L}=density of aqueous liquid.

For example, if A_{S} is 25 grams/gram and the ratio ρ_{S}/ρ_{L} is 1.5, a superabsorbent domain (or plurality of domains) having a mean swollen diameter of 1000 microns would have a mean unswollen diameter of 296 microns. The relationship between swollen and unswollen diameters is important because the superabsorbent polymer precursor composition(s) are applied to the substrate in controlled domain sizes based on the unswollen diameters, yet the controlled spacing between the domains must be based on the fully swollen diameters.

For purposes of the present invention, the superabsorbent polymer domains 14 may have a mean unswollen (dry) diameter of about 50 to about 1000 microns. The superabsorbent polymer precursor composition(s) may be applied to the substrate in domains having about the same unswollen (dry) diameter. However, the invention is not limited to this range of unswollen domain diameters. Instead, the invention is directed to absorbent structures which satisfy the relationships between mean fully swollen domain diameters, mean spacing, and regularity as explained below.

In order for the absorbent structure to provide full, unobstructed capillary action even when the superabsorbent polymer domains are fully swollen, the spacing between the superabsorbent polymer domains should be a) regular, and b) in excess of the mean fully swollen superabsorbent domain diameter. The term “spacing” is defined, for each superabsorbent polymer domain, as the center-to-center distance between the superabsorbent polymer domain and the closest adjacent superabsorbent polymer domain when both are in the dry, unswollen state. The mean spacing is the average of the spacings for all of the superabsorbent polymer domains 14 in the absorbent structure 10. The term “regular spacing” means that the standard deviation of the spacings of in situ formed superabsorbent polymer domains 14 within the absorbent structure 10 is about 10% or less, suitably about 5% or less, suitably about 3% or less of the mean superabsorbent polymer domain diameter when the domains are in the dry, unswollen state. Because the term “spacing” is defined as a center-to-center distance, the standard deviations (expressed as percentage deviations from the mean spacing) may remain about the same as the absorbent structure 10 absorbs liquid and the superabsorbent polymer domains 14 swell, although the mean spacing may increase due to expansion of the absorbent structure.

By way of example, the mean spacing for the superabsorbent polymer domains 14 in the absorbent structure 10 may be about 150 to about 3000 microns. However, the invention is not limited to this range of mean spacing. In order to ensure capillary flow between the swollen superabsorbent polymer domains as shown in FIG. 3, the mean spacing should be at least about 5% greater than the mean superabsorbent polymer domain diameter when in the fully swollen state. The mean spacing may be at least about 10% greater, or at least about 15% greater than the mean fully swollen superabsorbent polymer domain diameter.

Put another way, the mean spacing S between superabsorbent polymer domains 14 exceeds the mean fully swollen diameter D_{swollen} by at least about 5%, suitably at least about 10%, suitably at least about 15%. By combining the foregoing principles, we arrive at an equation which permits as to design an absorbent structure 10 using in situ formed superabsorbent polymer domains having a known density and maximum absorbent capacity A_{S}:

$$\begin{matrix}S = {KD}_{swollen} \\ = {KD}_{unswollen} \sqrt[3]{( {A}_{S} \times \frac{ρS}{ρL} ) + 1}\end{matrix}$$

wherein K is at least 1.05 (for a 5% capillary margin), or

at least 1.10 (for a 10% capillary margin), or

at least 1.15 (for a 15% capillary margin).

For example, if a superabsorbent polymer domain has a mean dry, unswollen diameter of 300 microns, a maximum absorbent capacity of 30 grams/gram, and a density which is 1.5 times the density of the liquid being absorbed, the mean spacing S between superabsorbent polymer domains 14 should be at least:

$$\begin{matrix}S = {KD}_{swollen} \\ = 1.05 ( 300 ) \sqrt[3]{( 30 \times 1.5 ) + 1} \\ = 1129 microns\end{matrix}$$

The maintenance of capillary action and avoidance of gel blocking even when the superabsorbent polymer domains are fully swollen is thus dependent on three factors: a) the regular sizing of superabsorbent polymer domains formed in situ and bound to the substrate to avoid shifting, b) the regular spacing between superabsorbent polymer domains, and c) a mean spacing determined from the above equation, wherein K is at least 1.05, suitably at least 1.10, suitably at least 1.15. The application of the superabsorbent polymer precursor composition(s) in such a regular and controlled fashion to form the superabsorbent polymer domains having the desired regular diameter and spacing is achieved using the precision non-contact process, suitably the ink jet printing process described above.

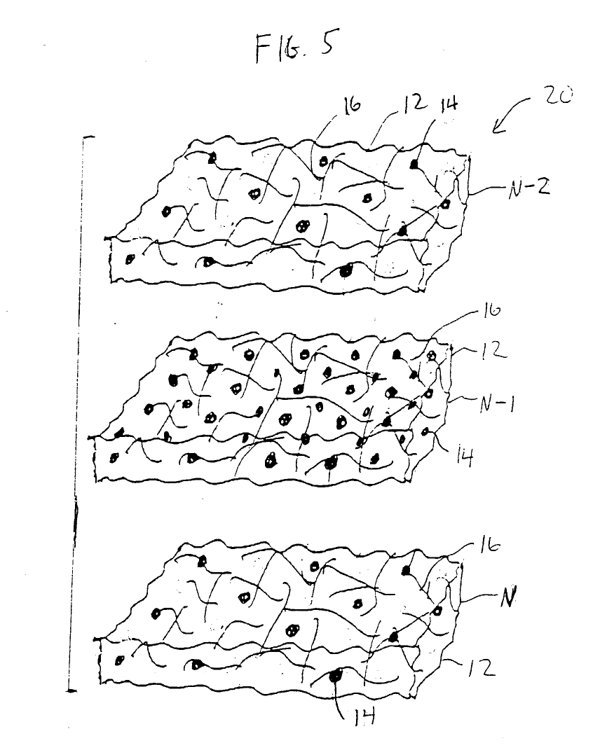

FIGS. 4 and 5 illustrate exploded views of multi-sectional absorbent structures 20 having “N” sections. Different sections may have a different concentration of superabsorbent polymer domains 14, i.e., a different mean spacing between superabsorbent polymer domains. The term “section” is defined herein to include both a) an individual layer in a multi-layer absorbent structure whose layers are separately formed and then combined, and b) an individual planar region or section in a single-layer absorbent structure which has a concentration gradient of superabsorbent polymer domains between a first major surface 22 and a second major surface 24 thereof. In other words, each section may represent a separately formed layer, or may represent a separate Z-directional region or portion of a single layer absorbent structure 20. Each section will typically represent an individual layer, with the layers being separately formed and then combined. The concentrations of superabsorbent polymer domains 14 may also vary in the X and Y directions within each section, provided that the minimum spacing limitations set forth herein are satisfied.

The multi-sectional absorbent structure 20 has “N” sections in the Z-direction, which is the direction perpendicular to the first major surface 22 and the second major surface 24. For a three-sectional absorbent structure 20 as shown in FIGS. 4 and 5, the sections are labeled sequentially as N (or 3), N−1 (or 2), and N−2 (or 1). For a multi-sectional absorbent structure having at least two, up to any higher number of absorbent sections in the Z-direction, the sections are labeled sequentially as N (or N−0), N−1 . . . , 1. Put another way the sections may be designated (N−i), where i ranges from 0 to N−1. For instance, in a 10-sectional absorbent structure 20, N=10 and the sections would be designated N, N−1, N−2, N−3, N−4, N−5, N−6, N−7, N−8 and N−9. In a multi-sectional absorbent structure 20, the number of sections N in the Z-direction may suitably range from two to about 20, suitably from three to about 15, suitably from four to about 10.

The individual sections in multi-sectional absorbent structure 20 should each satisfy the following equations for spacing between superabsorbent polymer domains 14 formed in situ on or in the individual sections:

$$\begin{matrix}S = {KD}_{swollen} \\ = {KD}_{unswollen} \sqrt[3]{( {A}_{S} \times \frac{ρS}{ρL} ) + 1}\end{matrix}$$

wherein K is at least 1.05 (for a 5% capillary margin), or

at least 1.10 (for a 10% capillary margin), or

at least 1.15 (for a 15% capillary margin), and

K is different for at least two different sections of the multi-sectional absorbent structure.

In one embodiment of the invention, illustrated in FIG. 4, the multi-sectional absorbent structure 20 has a concentration gradient of in situ formed polymer domains between a first major surface 22 and a second major surface 24, with the first major surface 22 being closest to the wearer of an absorbent article which includes the absorbent structure 20. As indicated above, the Z-directional sections for a multi-sectional absorbent structure with N sections may be labeled sequentially as N−0, N−1, . . . 1, or N−i where i=0, 1, . . . , (N−1). To achieve the desired concentration gradient, the spacing coefficient K in each section can be defined as:

K≧1.05+id

Where d represents a spacing differential from one section to the next adjacent section, and

i is an integer ranging sequentially from zero to N−1.

The spacing differential d may vary depending on a) the number of sections N, and b) the desired concentration gradient between the section N which is furthest from the wearer (where i=0) and the section N-(N−1) which is closest to the wearer (where i=N−1). The spacing differential d between each pair of adjacent sections may range from about 0.01 to about 3.0, suitably about 0.03 to about 2.0, suitably about 0.05 to about 1.0, suitably about 0.1 to about 0.5. Where the number of sections N is relatively large, the spacing differential d between adjacent sections maybe smaller, in order to achieve a suitable concentration gradient from one major surface to the other of the absorbent structure 20.

Alternatively, the spacing coefficient K for the embodiment illustrated in FIG. 4 may vary sequentially from each section to the next, according to the following equation:

K=Kₒ+id

wherein Kₒ≧1.05,

d represents a spacing differential from one section to the next, and

i ranges sequentially from zero to N−1.

FIG. 5 illustrates another embodiment of the invention, suitable for absorbent towels and the like, where the multi-sectional absorbent structure 20 has a concentration gradient of in situ formed polymer domains characterized by a minimal concentration (maximum spacing between domains) near both major surfaces 22 and 24 and a maximum concentration (minimal spacing between domains) in a central, intermediate section. To achieve the desired concentration gradient, the value K in each section can be defined as:

$$K ≧ 1.05 + d \vert \frac{N - 1}{2} - i \vert$$

Where d represents a spacing differential from one section to the next,

N is the number of Z-directional sections labeled sequentially as N−i where i=0, 1, . . . , N−1,

$$\vert \frac{N - 1}{2} - i \vert$$

is the absolute value of

$$( \frac{N - 1}{2} - i )$$

In the above embodiment, the maximum concentration (minimum spacing) of in situ formed superabsorbent polymer domains would occur in the intermediate section (or adjacent intermediate sections) where i is equal or nearly equal to (N−1)/2 and the value of

$$\vert \frac{N - 1}{2} - i \vert$$

is zero (where N is odd) or 0.5 (where N is even). The minimum concentration (maximum spacing) of the in situ formed superabsorbent polymer domains would occur in the outermost sections where i is equal to zero or N−1 and the value of

$$\vert \frac{N - 1}{2} - i \vert$$

is maximized. Again, the values for the concentration differential d may vary as indicated above, depending on the amount of gradient desired and the number of sections N in the absorbent structure 20.

Alternatively, the spacing coefficient K for the embodiment illustrated in FIG. 5 may vary sequentially from each section to the next, reaching a minimum value in a center section or sections and maximum values in both outermost sections, according the following equation:

$$K = {K}_{o} + d \vert \frac{N - 1}{2} - i \vert$$

wherein Kₒ≧1.05,

d is the spacing differential from one section to the next, and

N is the number of Z-directional sections labeled sequentially as N−i where i=0, 1, . . . , N−1.

If only a single superabsorbent polymer precursor composition is employed, it must include all of the reactants (monomer, catalyst, etc.) used to make a superabsorbent polymer. Thus, for purposes of the invention, the use of only one precursor composition is limited to situations where the chemical reaction can be delayed until the precursor composition contacts the fibrous web, including instances where a positive activation step (e.g., via heat, radiation or the like) is needed to initiate the chemical reaction. The use of at least two superabsorbent polymer precursor compositions which spontaneously react only when they contact each other, is desirable for purposes of the invention. This is because the two superabsorbent polymer precursor compositions can be maintained separately, and applied separately using different ink jet spraying or dipping nozzles or the like, so that they initially contact each other only when they are both present on or in the fibrous web.

In one suitable embodiment, a first superabsorbent polymer precursor composition includes a monomer, a crosslinking agent and a reducing agent. A second superabsorbent polymer precursor composition includes a monomer, a crosslinking agent and an oxidizing agent. The monomer in the second superabsorbent polymer precursor composition may be the same as the monomer in the first superabsorbent polymer precursor composition, or may be a different monomer which is copolymerizable with the monomer in the first superabsorbent polymer precursor composition. When the first and second precursor compositions are combined on or in the substrate, they spontaneously react to form the superabsorbent polymer domains.

A wide variety of superabsorbent polymer precursor compositions may be employed in the process of the invention. At least one polymer composition may include a monomer. Suitable superabsorbent-forming monomers include the following monomers and combinations thereof:

1. Carboxyl group-containing monomers: monoethylenically unsaturated mono or poly-carboxylic acids, such as (meth)acrylic acid (meaning acrylic acid or methacrylic acid. Similar notations are used hereinafter), maleic acid, fumaric acid, crotonic acid, sorbic acid, itaconic acid, and cinnamic acid;

2. Carboxylic acid anhydride group-containing monomers: monoethylenically unsaturated polycarboxylic acid anhydrides (such as maleic anhydride);

3. Carboxylic acid salt-containing monomers: water-soluble salts (alkali metal salts, ammonium salts, amine salts, etc.) of monoethylenically unsaturated mono- or poly-carboxylic acids (such as sodium (meth)acrylate, trimethylamine (meth)acrylate, triethanolamine (meth)acrylate, sodium maleate, methylamine maleate);

4. Sulfonic acid group-containing monomers: aliphatic or aromatic vinyl sulfonic acids (such as vinylsulfonic acid, allyl sulfonic acid, vinyltoluenesulfonic acid, stryrene sulfonic acid), (meth)acrylic sulfonic acids [such as sulfopropyl (meth)acrylate, 2-hydroxy-3-(meth)acryloxy propyl sulfonic acid];

5. Sulfonic acid salt group-containing monomers: alkali metal salts, ammonium salts, amine salts of sulfonic acid group containing monomers as mentioned above;

6. Hydroxyl group-containing monomers: monoethylenically unsaturated alcohols [such as (meth)allyl alcohol], monoethylenically unsaturated ethers or esters of polyols (alkylene glycols, glycerol, polyoxyalkylene polyols), such as hydroxethyl (meth)acrylate, hydroxypropyl (meth)acrylate, triethylene glycol (meth)acrylate, poly(oxyethylene oxypropylene) glycol mono (meth)allyl ether (in which hydroxyl groups may be etherified or esterified);

7. Amide group-containing monomers: vinylformamide, (meth)acrylamide, Balkyl (meth)acrylamides (such as N-methylacrylamide, Bhexylacrylamide), N,N-dialkyl (meth)acryl amides (such as N,N-dimethylacrylamide, N,N-di-n-propylacrylamide), N-hydroxyalkyl (meth)acrylamides [such as N-methylol (meth)acrylamide], N-hydroxyethyl (meth)acrylamide, N,N-dihydroxyalkyl (meth)acrylamides [such as N,N-dihydroxyethyl (meth)acrylamide], vinyl lactams (such as N-vinylpyrrolidone);

8. Amino group-containing monomers: amino group-containing esters (e.g., dialkylaminoalkyl esters, dihydroxyalkylaminoalkyl esters, morpholinoalkyl esters, etc.) of monoethylenically unsaturated mono- or di-carboxylic acid [such as dimethylaminoethyl (meth)acrylate, diethylaminoethyl (meth)acrylate, morpholinoethyl (meth)acrylate, dimethyl aminoethyl fumarate], heterocyclic vinyl compounds such as vinyl pyridines (e.g., 2-vinyl pyridine, 4-vinyl pyridine, N-vinyl pyridine), N-vinyl imidazole; and

9. Quaternary ammonium salt group-containing monomers: N,N,N-trialkyl-N-(meth)acryloyloxyalkylammonium salts [such as N,N,N-trimethyl-N-(meth)acryloyloxyethylammonium chloride, N,N,N-triethyl-N-(meth)acryloyloxyethylamonnium chloride, 2-hydroxy-3-(meth)-acryloyloxypropyl trimethyl ammonium chloride].

10. Ether-group containing monomers: methoxy polyethylene glycol (meth)acrylate; polyethylene glycol dimethacylate.

Particular superabsorbent forming monomers suitable for the process of the invention include without limitation aliphatic unsaturated monocarboxylic acids or salts thereof; specifically unsaturated monocarboxylic acids or salts thereof such as acrylic acid or salts thereof, methacrylic acid or salts thereof, or unsaturated dicarboxylic acids or salts thereof such as maleic acid or salts thereof, itaconic acid or salts thereof, which may be used alone or in combination.

Among these, acrylic acid or salts thereof and methacrylic acid or salts thereof are useful, especially acrylic acid or salts thereof.

Polymerizable monomers giving a water-absorbing polymer in the present invention are preferably aliphatic unsaturated carboxylic acids or salts thereof as described above, therefore, aqueous solutions of these polymerizable monomers are suitably aqueous solutions essentially containing an aliphatic unsaturated carboxylic acid or a salt thereof. As used here, the expression “essentially containing an aliphatic unsaturated carboxylic acid or a salt thereof” means that the aliphatic unsaturated carboxylic acid or a salt thereof is contained at about 50 mol % or more, suitably about 80 mol % or more on the basis of the total amount of the polymerizable monomer.

Suitable salts of aliphatic unsaturated carboxylic acids normally include water-soluble salts such as alkali metal salts, alkali earth metal salts, ammonium salts or the like. The neutrality is appropriately selected depending on the purpose, but 20-90 mol % of carboxyl group is preferably neutralized with an alkali metal salt or an ammonium salt in the case of acrylic acid. If the partial neutrality of an acrylic monomer is less than 20 mol %, the resulting water-absorbing polymer tends to have low water-absorbing capacity.

Acrylic monomers can be neutralized with alkali metal hydroxides or bicarbonates or ammonium hydroxide or the like, preferably alkali metal hydroxides such as sodium hydroxide and potassium hydroxide.

Superabsorbent-forming monomers may also include comonomers which are polymerizable along with any of the monomers listed above. The comonomers may form part of the same superabsorbent polymer precursor composition as the primary monomer, or may be part of a different superabsorbent polymer precursor composition, and may be added to the fibrous mixture using the same or different streams. Where the primary monomer is an aliphatic unsaturated carboxylic acid, suitable comonomers include without limitation secondary monomers such as (meth)acrylamide, (poly)ethylene glycol (meth)acrylate, 2-hydroxyethyl (meth)acrylate or even slightly water-soluble monomers including acrylate capped urethanes, acrylic alkyl esters such as methyl acrylate or ethyl acrylate may also be copolymerized in an amount within a range that does not affect performance of the resulting water-absorbing polymers in the present invention. As used herein, the term “(meth)acryl” means both “acryl” and “methacry.”

Where two superabsorbent polymer precursor compositions are combined into a redox system as described above, a crosslinking agent (“crosslinker”) is also present in the first superabsorbent polymer precursor composition and in the second superabsorbent polymer precursor composition. The crosslinker generally improves the water-absorbing performance of the resulting superabsorbent polymer. The crosslinker used in the first superabsorbent polymer precursor composition may be the same or different as the crosslinker used in the second superabsorbent polymer precursor composition. The crosslinker(s) may be present in the first and second superabsorbent polymer precursor compositions at about 0.001 to about 1% by weight, particularly about 0.01 to about 0.5% by weight, based on the weight of the monomer(s).

Useful crosslinkers include divinyl compounds copolymerizable with the monomer(s) such as N,N′-methylenebis(meth)acrylamide, (poly)ethylene glycol di(meth)acrylate and water-soluble compounds having two or more functional groups capable of reacting with a carboxylic acid including polyglycidyl ethers such as ethylene glycol diglycidyl ether, and polyethylene glycol diglycidyl ether. Among them, N,N′-methylenebis (meth)acrylamide is particularly useful.

The first superabsorbent polymer precursor composition also includes a reducing agent. The reducing agent should be capable of forming a redox system with the oxidizing agent in the second superabsorbent polymer precursor composition. The reducing agent maybe present at about 0.001 to about 10% by weight, suitably about 0.01 to about 2% by weight, based on the weight of the superabsorbent-forming monomer in the first precursor composition. Suitable reducing agents include sulfites such as sodium sulfite or sodium hydrogensulfite, sodium thiosulfate, cobalt acetate, copper sulfate, ferrous sulfate, ferrous ammonium sulfate, sodium metabisulfite, tertiary amines or diamines, L-ascorbic acid or L-ascorbic acid alkali metal salts, etc. Among others, L-ascorbic acid or L-ascorbic acid alkali metal salts are particularly suitable.

The second superabsorbent polymer precursor composition also includes an oxidizing agent. The oxidizing agent should be capable of forming a redox system with the reducing agent in the first superabsorbent polymer precursor composition. The oxidizing agent may be present at about 0.001 to about 10% by weight, suitably about 0.01 to about 2% by weight, based on the weight of the superabsorbent-forming monomer in the second precursor composition. Suitable oxidizing agents include hydrogen radical generator and a reducing agent. Such oxidizing agents include hydrogen peroxide, potassium bromate, N-bromosuccinimide, persulfates such as ammonium persulfate, sodium persulfate, or potassium persulfate, peroxides including hydroperoxides such as 1-butyl hydroperoxide or cumene hydroperoxide, secondary cerium salts, permanganates, chlorites, hypochlorites, etc., among which hydrogen peroxide is particularly suitable.

The first and second superabsorbent polymer precursor compositions may be provided in an organic or inorganic solvent, suitably water. The concentration of polymerizable monomer(s) in an aqueous polymerizable monomer solution essentially containing an aliphatic unsaturated carboxylic acid or a salt thereof as described above is about 20% or more, particularly about 25% or more. Concentrations less than about 20% by weight are less desirable because excessive dilution may cause the resulting water-absorbing polymer to be applied too thinly, resulting in insufficient water-absorbing capacity. The monomer concentration may range up to about 80% by weight in respect of handling of the polymerization reaction solution. A viscosity modifier and/or surfactant may also be added to the solution.

The first and second superabsorbent polymer precursor compositions may be applied to the substrate using any precision non-contact process which is capable of applying the first and second precursor compositions in the same locations, without combining the first and second precursor compositions before they contact the substrate. If the first and second precursor compositions are applied to the substrate at different locations, they may not combine or react with each other to form domains of superabsorbent polymer. If the first and second precursor compositions are combined with each other before they contact the substrate, the advantages of in situ superabsorbent polymer formation may be lost to the extent that a superabsorbent polymer is formed apart from the substrate. The advantages of in situ superabsorbent polymerization (especially adhesion to fixed locations on the substrate) are best achieved when a) the first and second superabsorbent polymer precursor compositions first contact each other at about the same time that they first contact the substrate, or b) one of the superabsorbent polymer precursor compositions is first applied to the substrate, then the other is applied at the same locations.

When two superabsorbent polymer precursor compositions are employed, as in the above-described redox system, they may both be added to the same controlled spaced-apart locations using a precision non-contact process, such as an ink jet printing process. Alternatively, only one of the superabsorbent polymer precursor compositions may be added to the controlled spaced apart locations using the precision non-contact process. In this case, the other superabsorbent polymer precursor composition may be added by coating, dipping, spraying or another uniform non-contact coating process. In the latter case, the first and second superabsorbent polymer precursor compositions will chemically react with each other to form domains only in the controlled spaced apart locations where both superabsorbent polymer precursor compositions coexist.

The first and second superabsorbent polymer precursor compositions are added separately, meaning they are not mixed together or otherwise in contact with each other before being added to the substrate. The monomer(s), crosslinking agent(s), oxidizing and reducing agents are selected so that the polymerization reaction for making superabsorbent polymer proceeds spontaneously on or in the substrate, when the precursor compositions contact each other.

The first and second precursor compositions chemically react with each other at the controlled spaced-apart locations to form discrete, spaced-apart domains of superabsorbent polymer, adhering to the substrate. When the substrate is a fibrous web, the domains of superabsorbent material may be formed on or around the fibers in the substrate, and adhere to the fibers. The superabsorbent microdomains may have an average diameter of about 50 to about 1000 microns when dry and unswollen. As explained above, the absorbent structure 10 of the invention is not limited to this size range. Individual superabsorbent polymer domains maybe spaced-apart from center-to-center from the closest adjacent domains by an average of about 150 to about 3000 microns when dry and unswollen. As explained above, the absorbent structure of the invention is not limited to this particular spacing. The spacing between the microdomains and the fully swollen size of the superabsorbent polymer domains are coordinated so that the absorbent structure will have unobstructed liquid intake and distribution even when the superabsorbent polymer domains are swollen to their maximum capacities. The pattern, size, depth of penetration and spacing of the microdomains may vary depending on the design and operating conditions of the non-contact printing device. Because of the in situ polymerization, the locations of the domains are fixed and the domains of superabsorbent polymer adhere firmly to the substrate at the fixed locations.

Process conditions, feed rates, and the like should also be tailored to produce the desired composition for the absorbent structure. For example, when the substrate is a fibrous web, the process conditions and feed rates may be tailored to produce an absorbent structure having the following compositions:

Composition, % By Weight

| | Hydrophilic | Superabsorbent Polymer | Thermoplastic |
|---|---|---|---|
| | Fibers | Formed In Situ | Fibers |
| Broad | 25-99 | 1-75 | 0-74 |
| Intermediate | 35-80 | 15-65 | 0-45 |
| Narrow | 40-70 | 20-50 | 10-30 |

Examples of superabsorbent polymers which may be formed in situ include without limitation the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), and mixtures and copolymers thereof.

The absorbent structure of the invention is useful in a wide variety of absorbent articles, particularly as an absorbent core material in personal care absorbent articles, medical absorbent articles, tissue and towel articles. Personal care absorbent articles include diapers, training pants, swim wear, absorbent underpants, baby wipes, adult incontinence products, feminine hygiene products and the like. Medical absorbent articles include medical absorbent garments, drapes, gowns, bandages, wound dressings, underpads, wipes, and the like. Tissue and towel absorbent articles include facial and bathroom tissue, paper towels such as kitchen towels, away-from-home towels, wet wipes, and the like.

Test Method for Determining Absorbent Capacity

The following test can be used to determine the maximum absorbency A_{S} of a superabsorbent polymer, for use in the above equations. As used herein, the Centrifuge Retention Capacity (CRC) is a measure of the absorbent capacity of the superabsorbent material retained after being subjected to centrifugation under controlled conditions. The CRC can be measured by placing a sample of the material to be tested into a water-permeable bag which will contain the sample while allowing the test solution (0.9 percent NaCl solution) to be freely absorbed by the sample. A heat-sealable tea bag material (available from Dexter Nonwovens of Windsor Locks, Conn., U.S.A., as item #1234T) works well for most applications. The bag is formed by folding a 5-inch by 3-inch sample of the bag material in half and heat sealing two of the open edges to form a 2.5-inch by 3-inch rectangular pouch. The heat seals should be about 0.25 inch inside the edge of the material. After the sample is placed in the pouch, the remaining open edge of the pouch is also heat-sealed. Empty bags are also made to be tested with the sample bags as controls. A sample size is chosen such that the teabag does not restrict the swelling of the material, generally with dimensions smaller than the sealed bag area (about 2-inch by 2.5 inch). A sample size of about 0.2 grams dry superabsorbent polymer is suitable. Three sample bags are tested for each material.

The sealed bags are submerged in a pan of 0.9% NaCl solution. After wetting, the samples remain in the solution for 30 minutes, at which time they are removed from the solution and temporarily laid on a non-absorbent flat surface.

The wet bags are then placed into the basket of a suitable centrifuge capable of subjecting the samples to a g-force of 350. (A suitable centrifuge is a Heraeus LABOFUGE 400, Heraeus Instruments, part number 75008157, available from Heraeus Infosystems GmbH, Hanau, Germany). The bags are centrifuged at 1600 rpm for 3 minutes (target g-force of 350). The bags are removed and weighed. The amount of fluid absorbed and retained by the material, taking into account the fluid retained by the bag material alone, is the Centrifuge Retention Capacity of the material, expressed as grams of fluid per gram of material.

While the embodiments of the invention disclosed herein are presently preferred, various modifications and improvements can be made without departing from the spirit and scope of the invention. The scope of the invention is indicated by the appended claims, and all changes that fall within the meaning and range of equivalents are intended to be embraced therein.

We claim:

1. An absorbent structure, comprising:
a substrate; and
a multiplicity of superabsorbent polymer domains formed in situ on or in the substrate and bound to the substrate;
the superabsorbent polymer domains having a mean unswollen domain diameter D_{unswollen}, and an unswollen domain diameter standard deviation of about 10% or less;
the superabsorbent polymer domains having a mean unswollen spacing S defined by the following equation:
$$S = {KD}_{unswollen} \sqrt[3]{( {A}_{S} \times \frac{{ρ}_{S}}{{ρ}_{L} } ) + 1}$$
wherein K is at least about 1.05,
A_{S} is the maximum absorbency of the superabsorbent, expressed as grams of aqueous liquid absorbed per gram of superabsorbent,
ρ_{S} is the density of the superabsorbent in the dry, unswollen state, and
ρ_{L} is the density of the aqueous liquid being absorbed.

2. The absorbent structure of claim 1, wherein the unswollen domain diameter standard deviation is about 5% or less.

3. The absorbent structure of claim 1, wherein the unswollen domain diameter standard deviation is about 3% or less.

4. The absorbent structure of claim 1, wherein the superabsorbent polymer domains have an unswollen spacing standard deviation of about 10% or less.

5. The absorbent structure of claim 1, wherein the superabsorbent polymer domains have an unswollen spacing standard deviation of about 5% or less.

6. The absorbent structure of claim 1, wherein the superabsorbent polymer domains have an unswollen spacing standard deviation of about 3% or less.

7. The absorbent structure of claim 1, wherein K is at least about 1.10.

8. The absorbent structure of claim 1, wherein K is at least about 1.15.

9. An absorbent article comprising the absorbent structure of claim 1.

10. An absorbent structure, comprising:
a substrate; and
a multiplicity of superabsorbent polymer domains formed in situ on or in the substrate and bound to the substrate;
the superabsorbent polymer domains having a mean fully swollen diameter D_{swollen}, a swollen diameter standard deviation of about 10% or less, and a mean unswollen diameter of about 50 to about 1000 microns;
the superabsorbent polymer domains having an unswollen spacing standard deviation of about 10% or less and a mean unswollen spacing S defined by the following equation:
S=KD_{unswollen}
wherein K is at least about 1.05

11. The absorbent structure of claim 10, wherein K is at least about 1.10.

12. The absorbent structure of claim 10, wherein K is at least about 1.15.

13. The absorbent structure of claim 10, wherein D_{swollen} is about 150 to about 3000 microns.

14. The absorbent structure of claim 10, wherein the swollen diameter standard deviation is about 5% or less.

15. The absorbent structure of claim 10, wherein the swollen diameter standard deviation is about 3% or less.

16. The absorbent structure of claim 10, wherein the unswollen spacing standard deviation is about 5% or less.

17. The absorbent structure of claim 10, wherein the unswollen spacing standard deviation is about 3% or less.

18. An absorbent article comprising the absorbent structure of claim 10.

19. A method of making an absorbent structure, comprising the steps of:
providing a first superabsorbent polymer precursor composition including a superabsorbent-forming monomer, a crosslinking agent and a reducing agent;
providing a second superabsorbent polymer precursor composition including a superabsorbent-forming monomer, a crosslinking agent and an oxidizing agent;
providing a pre-formed substrate;
adding at least one of the first and second superabsorbent polymer precursor compositions to the substrate web at a plurality of spaced-apart locations using a precision non-contact process;
adding the other of the first and second superabsorbent polymer precursor compositions to the substrate using a non-contact process; and
chemically reacting the first and second superabsorbent polymer precursor compositions at the plurality of spaced-apart locations to form a plurality of discrete, spaced-apart domains of superabsorbent polymer adhering to the substrate;
wherein the domains of superabsorbent polymer have a mean unswollen spacing S defined by the following equation:
$$S = {KD}_{unswollen} \sqrt[3]{( {A}_{S} \times \frac{{ρ}_{S}}{{ρ}_{L} } ) + 1}$$
wherein K is at least about 1.05,
D is the mean unswollen diameter of the superabsorbent polymer domains,
A_{S} is the maximum absorbency of the superabsorbent, in grams of liquid per gram of superabsorbent,
ρ_{S} is the density of the superabsorbent in the dry, unswollen state, and
ρ_{L} is the density of the aqueous liquid being absorbed.

20. The method of claim 19, wherein the other of the first and second superabsorbent polymer precursor compositions is added to the substrate at the plurality of spaced-apart locations.

21. The method of claim 19, wherein at least one of the first and second superabsorbent polymer precursor compositions is added using an ink jet printing process.

22. The method of claim 20, wherein each of the first and second superabsorbent polymer precursor compositions is added using an inkjet printing process.

23. The method of claim 19, wherein the spaced-apart locations have an average diameter of about 50 to about 1000 microns and an average spacing of about 150 to about 3000 microns.

24. The method of claim 19, wherein the monomer in the first superabsorbent polymer precursor composition and the monomer in the second superabsorbent polymer precursor composition each comprises a compound selected from the group consisting of aliphatic unsaturated monocarboxylic acids and their salts, methacrylic acids and their salts, unsaturated dicarboxylic acids and their salts, and combinations thereof.

25. The method of claim 19, wherein the monomer in the first superabsorbent polymer precursor composition and the monomer in the second superabsorbent polymer precursor composition each comprises a compound selected from the group consisting of acrylic acid and its salts, methacrylic acid and its salts, and combinations thereof.

26. The method of claim 19, wherein the crosslinking agent in the first superabsorbent polymer precursor composition and the crosslinking agent in the second superabsorbent polymer precursor composition each comprises a compound selected from the group consisting of N₁N′-methylenebis(meth)acrylamide, (poly)ethylene glycol, di(meth)acrylate, polyglycidyl ethers, and combinations thereof.

27. The method of claim 19, wherein the reducing agent comprises a compound selected from the group consisting of sodium sulfite, sodium hydrogensulfite, sodium metabisulfite, tertiary amines, diamines, L-ascorbic acid, alkali metal salts of L-ascorbic acid, and combinations thereof.

28. The method of claim 19, wherein the oxidizing agent comprises a compound selected from the group consisting of hydrogen peroxide, potassium bromate, N-bromosuccinimide, ammonium persulfate, sodium persulfate, potassium persulfate, hydroperoxides, secondary cerium salts, permanganates, chlorites, hypochlorites, and combinations thereof.

29. A multi-sectional absorbent structure comprising a plurality N of sections between a first major surface and a second major surface of the structure, each of the sections comprising:
a substrate; and
a multiplicity of superabsorbent polymer domains formed in situ on or in the substrate and bound to the substrate;
the superabsorbent polymer domains having a mean unswollen domain diameter D_{unswollen}, and an unswollen domain diameter standard deviation of about 10% or less;
the superabsorbent polymer domains having a mean unswollen spacing S defined by the following equation:
$$S = {KD}_{unswollen} \sqrt[3]{( {A}_{S} \times \frac{{ρ}_{S}}{{ρ}_{L} } ) + 1}$$
wherein K is at least about 1.05, and is different for at least two of the sections,
A_{S} is the maximum absorbency of the superabsorbent, expressed as grams of aqueous liquid absorbed per gram of superabsorbent,
ρ_{S} is the density of the superabsorbent in the dry, unswollen state, and
ρ_{L} is the density of the aqueous liquid being absorbed.

30. The multi-sectional absorbent structure of claim 29, wherein the plurality of sections is designated sequentially as N−i, where i=0, 1, . . . , (N−1), and wherein the value K is relatively higher in the section corresponding to i=(N−1) than in the section corresponding to i=0.

31. The multi-sectional absorbent structure of claim 30, wherein the value K in each section is defined as:
K≧1.05+id
wherein d represents a spacing differential of about 0.01 to about 3.0, and
i is an integer ranging sequentially from zero to N−1.

32. The multi-sectional absorbent core of claim 30, wherein the value K in each section is defined as:
K=Kₒ+id
wherein Kₒ≧1.05,
d represents a spacing differential of about 0.01 to about 3.0, and
i is an integer ranging sequentially from zero to N−1.

33. The multi-sectional absorbent structure of claim 30, wherein d is about 0.03 to about 2.0.

34. The multi-sectional absorbent structure of claim 30, wherein d is about 0.05 to about 1.0.

35. The multi-sectional absorbent structure of claim 30, wherein d is about 0.1 to about 0.5.

36. The multi-sectional absorbent structure of claim 29, wherein the plurality of sections is designated sequentially as N−i, where i=0, 1, . . . , (N−1), and wherein the value K is relatively higher in outermost sections corresponding to i=0 and i=(N−1) than in an intermediate section or sections.

37. The multi-sectional absorbent structure of claim 36, wherein the value K in each section is defined as:
$$K \geq 1.05 + d \vert \frac{N - 1}{2} - i \vert$$
where d represents a spacing differential of about 0.01 to about 3.0, and
i ranges sequentially from zero to N−1.

38. The multi-sectional absorbent core of claim 36, wherein the value K in each section is defined as:
$$K = {K}_{o} + d \vert \frac{N - 1}{2} - i \vert ,$$
wherein Kₒ≧1.05,
d represents a spacing differential of about 0.1 to about 3.0, and
i is an integer ranging sequentially from zero to N−1.

39. The multi-sectional absorbent structure of claim 37, wherein d is about 0.03 to about 2.0.

40. The multi-sectional absorbent structure of claim 37, wherein d is about 0.05 to about 1.0.

41. The multi-sectional absorbent structure of claim 37, wherein d is about 0.1 to about 0.5.

42. The multi-sectional absorbent structure of claim 29, wherein N is about 2 to about 20.

43. The multi-sectional absorbent structure of claim 29, wherein N is about 3 to about 15.

44. The multi-sectional absorbent structure of claim 29, wherein N is about 4 to about 20.

45. An absorbent article comprising the multi-sectional absorbent structure of claim 29.
